(19) United States
(12) Patent Application Publication
(10) Pub. No.: US 2026/0316988 A1
(43) Pub. Date: Oct. 15, 2026

(54) PEELABLE CONTAINER, METHOD FOR MANUFACTURING PEELABLE CONTAINER, AND APPARATUS FOR MANUFACTURING PEELABLE CONTAINER

(71) Applicant: NISSEI ASB MACHINE CO., LTD., Nagano (JP)

(72) Inventors: Toshiteru OIKE, Nagano (JP); Haruo SAKATO, Nagano (JP)

(73) Assignee: NISSEI ASB MACHINE CO., LTD., Nagano (JP)

(21) Appl. No.: 19/478,107

(22) PCT Filed: Apr. 26, 2024
(86) PCT No.: PCT/JP2024/016423

§ 371 Date: Jan. 23, 2026

(30) Foreign Application Priority Data
Apr. 27, 2023 (JP) 2023-073422

(51) Int. Cl. B65D 1/02; B29C 45/16; B29C 45/26; B29C 49/06; B29C 49/22; B29L 31/00; B65D 23/02

(52) U.S. Cl. CPC B65D 1/0215; B29C 45/16; B29C 45/26; B29C 49/06; B29C 49/22; B65D 23/02; B29L 2031/7158; B65D 2205/02

(57) ABSTRACT

A delamination container includes: a neck portion which is formed of an inner layer, has a mouth portion on one side, and has a screw thread formed on an outer periphery; and a container main body portion which is connected to the other side of the neck portion, and has an outer layer made of a material different from a material of the inner layer laminated on an outer side of the inner layer. A protruding portion having a diameter larger than a diameter of the neck portion is formed on one side of the container main body portion adjacent to the neck portion, and a lid body is screwable with the neck portion of the inner layer. By displacing the inner layer on the one side or in a circumferential direction with respect to the outer layer by rotation of the lid body in a closing direction, a vent for guiding air between the inner layer and the outer layer is formed on the one side of the container main body portion.

### BACKGROUND OF THE INVENTION

### Field of the Invention

The present invention relates to a delamination container, a method for manufacturing the delamination container, and an apparatus for manufacturing the delamination container.

### Description of the Related Art

Conventionally, resin-made containers have been applied to various applications, and various resin-made containers each having a plurality of resin layers have also been put to practical use. For example, there is a known resin-made delamination container having a two-layer structure of an inner layer and an outer layer, in which the inner layer is peeled from the outer layer according to discharge of contents. This type of delamination container is also referred to as an airless bottle, and is used, for example, as a container of a seasoning liquid such as soy sauce, a cosmetic liquid of cosmetics, a liquid detergent such as shampoo or hand soap, or a liquid chemical used for disinfection, sterilization, and the like.

In this type of delamination container, the inner layer and the outer layer may be molded using different materials. When the inner layer and the outer layer are made of different materials, it is necessary to separate the inner layer container from the outer layer container and to sort the inner layer container and the outer layer container according to the type of material at the time of recycling. As an example, JP 2022-51111 A discloses a double container in which a flange portion engaged with a cap is formed at an upper end of a mouth portion of an inner bag, and the contracted inner bag can be separated from an outer shell together with the cap.

In the container of JP 2022-51111 A, the inner bag is locked to the cap by hooking the flange at the upper end of the mouth portion to the inside of the cap. Therefore, in the container of JP 2022-51111 A, the inner bag may be unintentionally removed from the cap by a force in a pulling direction while the inner bag is being pulled out from the outer shell, which may interfere with removal of the inner bag from the outer shell.

In addition, in the delamination container, it is necessary to form a vent for guiding air between the outer layer and the inner layer in order to peel the inner layer from the outer layer, but there is also a demand for an idea capable of easily forming such a vent.

### SUMMARY OF THE INVENTION

A delamination container according to an aspect of the present invention includes: a neck portion which is formed of an inner layer, has a mouth portion on one side, and has a screw thread formed on an outer periphery; and a container main body portion which is connected to the other side of the neck portion, and has an outer layer made of a material different from a material of the inner layer laminated on an outer side of the inner layer. A protruding portion having a diameter larger than a diameter of the neck portion is formed on one side of the container main body portion adjacent to the neck portion, and a lid body is screwable with the neck portion of the inner layer. By displacing the inner layer on the one side or in a circumferential direction with respect to the outer layer by rotation of the lid body in a closing direction, a vent for guiding air between the inner layer and the outer layer is formed on the one side of the container main body portion.

Further features of the present invention will become apparent from the following description of exemplary embodiments with reference to the attached drawings.

### BRIEF DESCRIPTION OF THE DRAWINGS

FIG. 1A is a longitudinal cross-sectional view illustrating a configuration example of a preform of the present embodiment, and FIG. 1B is a cross-sectional view taken along line A-A of FIG. 1A.

FIG. 2 is a cross-sectional view illustrating a configuration example of a delamination container of the present embodiment.

FIGS. 3A and 3B are enlarged views illustrating the vicinity of a neck portion when a lid body is attached to the delamination container.

FIGS. 4A and 4B are enlarged views illustrating the vicinity of the neck portion when an outer layer and an inner layer of the delamination container are sorted.

FIG. 5 is a view illustrating an example of forming a gap between the outer layer and the inner layer of the neck portion.

FIG. 6 is a diagram schematically illustrating a configuration of a blow molding apparatus of the present embodiment.

FIG. 7 is a view illustrating a configuration example of a first injection molding unit.

FIG. 8 is a view illustrating a protruding state of a valve pin in the first injection molding unit.

FIG. 9 is a view illustrating a configuration example of a second injection molding unit.

FIG. 10 is a flowchart indicating steps of a method for manufacturing the container.

FIG. 11 is a view illustrating a configuration of a protrusion and a recessed portion of a preform (delamination container) according to a first modification.

FIGS. 12A to 12C are views illustrating a blow molding step in a blow molding unit according to a second modification.

FIGS. 13A to 13C are plan views of a bottom mold illustrated in FIGS. 12A to 12C.

FIG. 14 is a cross-sectional view illustrating a configuration example of a delamination container manufactured in the second modification.

### DESCRIPTION OF THE EMBODIMENTS

Hereinafter, an embodiment of the present invention will be described with reference to the drawings.

In the embodiment, for easy understanding, structures and elements of parts other than a main part of the present invention will be described in a simplified or omitted manner. In the drawings, the same elements are denoted by the same reference numerals. Note that the shapes, dimensions, and the like of elements illustrated in the drawings are schematically illustrated, and do not indicate actual shapes, dimensions, and the like.

### Configuration Examples of Preform and Delamination Container

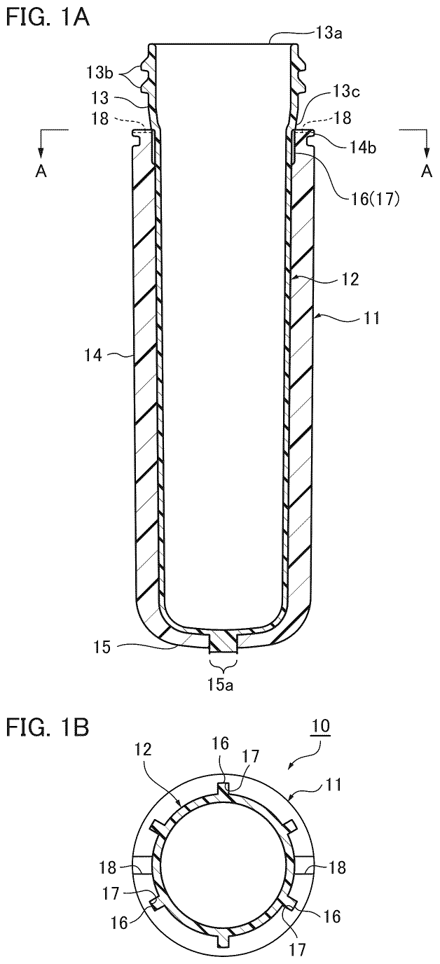

First, a configuration example of a preform for a delamination container according to the present embodiment and a configuration example of the delamination container will be described. FIG. 1A is a longitudinal cross-sectional view illustrating a configuration example of a preform 10 of the present embodiment, and FIG. 1B is a cross-sectional view taken along line A-A of FIG. 1A.

The entire shape of the preform 10 is a bottomed cylindrical shape in which a mouth portion 13a on one side is opened and the other side is closed. The preform 10 includes a body portion 14 formed in a cylindrical shape, a bottom portion 15 that closes the other side of the body portion 14, and a neck portion 13 formed on one side of the body portion 14 and including the mouth portion 13a.

The preform 10 has a two-layer structure in which an inner layer 12 is laminated on an inner side of an outer layer 11. The outer layer 11 and the inner layer 12 are made of different thermoplastic resin materials by two-stage injection molding as described later. The outer layer 11 is made of a synthetic resin having excellent moldability and transparency. On the other hand, the inner layer 12 is made of a synthetic resin having a property of stably storing contents of the container and being able to suppress deterioration (oxidation) (for example, moisture barrier property, gas barrier property, heat resistance, and chemical resistance). As the resin material of the outer layer 11, a resin material having a melting point higher than that of the resin material of the inner layer 12 is selected. An inner peripheral surface of the outer layer 11 and an outer peripheral surface of the inner layer 12 have a tapered shape in which the diameter decreases toward a lower side (the other side). Note that an outer peripheral surface of the outer layer 11 and an inner peripheral surface of the inner layer 12 may also have a tapered shape similarly.

Hereinafter, the resin material of the outer layer 11 is also referred to as a first resin material, and the resin material of the inner layer 12 is also referred to as a second resin material.

A combination of the first resin material and the second resin material can be appropriately selected according to specifications of the delamination container. Specific examples of the type of material include PET (polyethylene terephthalate), PEN (polyethylene naphthalate), PCTA (polycyclohexanedimethylene terephthalate), Tritan (registered trademark, co-polyester manufactured by Eastman Chemical Co., Ltd.) , PP (polypropylene), PE (polyethylene), PC (polycarbonate), PES (polyethersulfone), PPSU (polyphenylsulfone), PS (polystyrene), COP/COC (cyclic olefin-based polymer), PMMA (polymethyl methacrylate: acrylic), PLA (polylactic acid), and low density polyethylene (LDPE).

As an example, the first resin material is PET, and the second resin material is any of PP, LDPE (low density polyethylene), and L-LDPE (linear low density polyethylene). A melting point of PP is about 160 to 170 °C, and a melting point of LDPE is about 105 to 120 °C A melting point of L-LDPE is about 114 to 126 °C. On the other hand, a melting point of PET is higher than melting points of PP, LDPE, and L-LDPE, and is about 245 to 260 °C L-LDPE has higher tensile strength, impact resistance, and puncture resistance properties than LDPE.

The inner layer 12 is formed in a bottomed cylindrical shape over the neck portion 13, the body portion 14, and the bottom portion 15 of the preform. The outer layer 11 covers an outer peripheral side of the inner layer 12 over the body portion 14 and the bottom portion 15 of the preform 10. The inner layer 12 protrudes to one side from an end portion of the body portion of the outer layer 11, and the neck portion 13 of the preform 10 is formed at a portion of the inner layer 12 protruding from the outer layer 11. Note that a screw thread 13b is formed on an outer peripheral surface of the neck portion 13 of the inner layer 12. Furthermore, a step portion 13c having a larger diameter than a lower portion of the neck portion 13 and having a circular (or ring-shaped) cross section is formed at a lower end of the neck portion 13.

In addition, on an outer peripheral portion of the inner layer 12, one or more longitudinal ribs 16 extending in an axial direction from the vicinity of a boundary between the neck portion 13 and the body portion 14 toward the other side and protruding outward in a radial direction of the inner layer 12 on a plane orthogonal to the axial direction are formed. The longitudinal rib 16 of the present embodiment is an example of a protrusion formed on the outer periphery of the inner layer 12 and extending in the axial direction, and for example, a plurality of longitudinal ribs 16 are formed at intervals in a circumferential direction of the inner layer 12. FIG. 1B illustrates an example in which six longitudinal ribs 16 are formed on the outer periphery of the inner layer 12, but the number of longitudinal ribs 16 may be one or a plural number other than six.

The longitudinal ribs 16 are engaged with recessed portions 17 formed at corresponding positions of the longitudinal ribs 16 on an inner periphery of the outer layer 11, respectively, and function as rotation preventing portions of the inner layer 12 in the circumferential direction with respect to the outer layer 11. When a torque about the axial direction is applied to the neck portion 13 of the inner layer 12, the longitudinal rib 16 transmits the torque to the outer layer 11 by engagement with the recessed portion 17 of the outer layer 11, and suppresses the inner layer 12 from being displaced in a rotation direction with respect to the outer layer 11. Note that the axial length and the radial protrusion amount of the longitudinal rib 16 are appropriately set so as to maintain engagement with the recessed portion 17, for example, even in a state where a slight gap is formed between the outer layer 11 and the inner layer 12.

In addition, one or more grooves 18 extending in the radial direction and communicating with an outer peripheral side and an inner peripheral side of the outer layer 11 are formed in an end portion of the outer layer 11 on one end side (a portion adjacent to the neck portion 13). The groove 18 is an example of a flow path for introducing air outside the container toward a vent described later. FIG. 1B illustrates an example in which two grooves 18 are formed at intervals of 180 degrees in a circumferential direction of the outer layer 11, but the number of grooves 18 may be one or two or more. Furthermore, a protruding portion (first opening portion) 14b that is in contact with (is adjacent to) a lower surface of the step portion 13c of the neck portion 13 is formed at an end portion of the outer layer 11 on one end side. The protruding portion 14b has a circular cross section (or a ring-shaped cross section, excluding a portion of the recessed portion 17), an inner diameter of the protruding portion 14b is smaller than that of the step portion 13c, and an upper surface of the protruding portion 14b and a lower surface of the step portion 13c are in contact with each other. In addition, an outer diameter (diameter) of the protruding portion 14b is larger than an outer diameter of the neck portion 13 (specifically, outer diameters of the screw thread 13b and the step portion 13c of the neck portion 13).

In addition, in the bottom portion 15 of the preform 10, an opening portion 15a is formed through the outer layer 11 at a center of a bottom portion of the outer layer 11. The opening portion 15a of the outer layer 11 is closed from the inside by the inner layer 12.

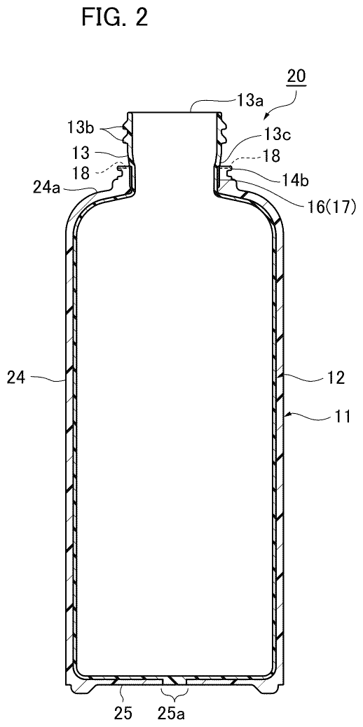

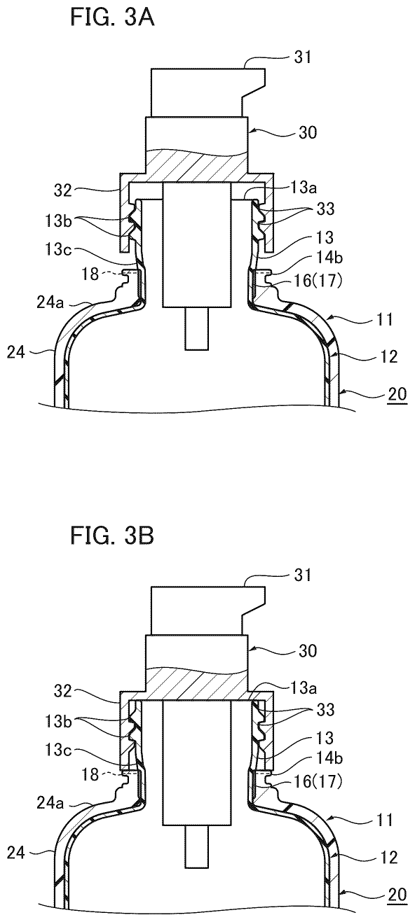

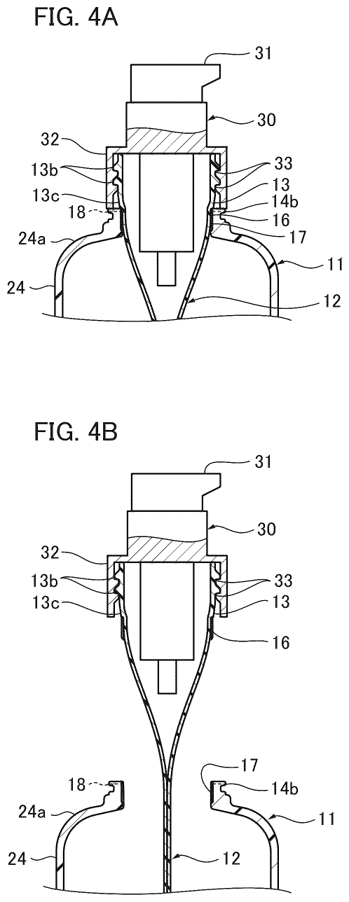

Next, a configuration example of a resin-made delamination container 20 according to the present embodiment will be described with reference to FIGS. 2 to 4. FIG. 2 is a cross-sectional view illustrating a configuration example of the delamination container 20 of the present embodiment. FIGS. 3A and 3B are enlarged views illustrating the vicinity of the neck portion when a lid body 30 is attached to the delamination container 20. FIGS. 4A and 4B are enlarged views illustrating the vicinity of the neck portion when the outer layer 11 and the inner layer 12 of the delamination container 20 are sorted.

As illustrated in FIG. 2, the delamination container 20 is a bottle-shaped resin-made container obtained by subjecting the preform 10 to stretch blow molding, and contains, for example, a seasoning liquid such as soy sauce. Note that the delamination container 20 may be used to store other contents such as a cosmetic liquid of cosmetics.

Similarly to the preform 10, the delamination container 20 has a two-layer structure in which the inner layer 12 is laminated on an inner side of the outer layer 11. The delamination container 20 includes the neck portion 13, a cylindrical body portion 24, a shoulder portion 24a connecting the neck portion 13 to one side of the body portion 24, and a bottom portion 25 closing the other side of the body portion 24. In the delamination container 20, contents are filled into an inner space of the inner layer 12. Note that the shoulder portion 24a, the body portion 24, and the bottom portion 25 are examples of the container main body portion.

In manufacture of the delamination container 20, the body portion 14 and the bottom portion 15 of the preform 10 are inflated by stretch blow, whereby the shoulder portion 24a, the body portion 24, and the bottom portion 25 of the delamination container 20 are shaped. Note that, as in the preform 10, an opening portion 25a (non-laminated portion, single layer portion) penetrating the outer layer 11 is formed at a center of the bottom portion 25 of the delamination container 20. A material of the inner layer 12 is filled in the opening portion 25a so as to close the opening portion 25a, and the inner layer 12 is exposed to the outside of the outer layer 11 in the vicinity of the opening portion 25a of the bottom portion 25 of the delamination container 20.

On the other hand, the neck portion 13 of the preform 10 and an upper end portion of the outer layer 11 are held by a neck mold 47b described later during blow molding, and the shape of the preform 10 is maintained as it is. Therefore, as illustrated in FIG. 2, the neck portion 13 of the delamination container 20 and the upper end portion of the outer layer 11 have similar configurations to that of the neck portion 13 of the preform 10 described above. That is, the neck portion 13 of the delamination container 20 has the step portion 13c, and the upper end portion of the outer layer 11 (a portion adjacent to the neck portion 13) has the protruding portion 14b. Note that the groove 18 and the recessed portion 17 are formed in the outer layer 11 at the upper end portion of the outer layer 11, and the longitudinal rib 16 is formed in the inner layer 12 at the portion.

As illustrated in FIGS. 3A and 3B, the lid body 30 for sealing the inner layer 12 is attached to the neck portion 13 of the delamination container 20 in an airtight state with respect to the inner layer 12. The lid body 30 includes, for example, a nozzle head 31 with a check valve (not illustrated) that discharges a predetermined amount of contents of the container according to an operation of pushing down a top portion, and a cylindrical cap portion 32 that covers an outer side of the neck portion 13. An inner screw thread 33 to be screwed with the screw thread 13b of the neck portion 13 is formed on an inner peripheral portion of the cap portion 32.

When contents are filled into the delamination container 20 and the lid body 30 is attached thereto, as illustrated in FIG. 3A, the cap portion 32 of the lid body 30 is put on the neck portion 13. Then, as illustrated in FIG. 3B, the lid body 30 is rotated with respect to the neck portion 13, and the inner screw thread 33 is screwed with the screw thread 13b of the neck portion 13 to fix the lid body 30 to the neck portion 13 of the delamination container 20. At this time, the cap portion 32 seals the mouth portion 13a with respect to outside air by contact between an upper end of the neck portion 13 and the cap portion 32. Note that an annular sealing material (not illustrated) may be disposed between the cap portion 32 and the neck portion 13, and the sealing material may be sandwiched between the cap portion 32 and the neck portion 13 to seal the mouth portion 13a.

In the delamination container 20 after blow molding, the outer layer 11 and the inner layer 12 are in close contact with each other. Here, when the lid body 30 is further rotated in the closing direction in a state where the screw thread 13b of the neck portion 13 is sufficiently screwed with the inner screw thread 33 (state where the lid body 30 is fixed to the neck portion 13), a torque in the closing direction acts on the lid body 30 and the delamination container 20, and a reaction force against the torque is generated in the outer layer 11 held in order to close the lid body 30.

At this time, engagement between the recessed portion 17 and the longitudinal rib 16 causes resistance to displacement of the inner layer 12 in a circumferential direction with respect to the outer layer 11, and no displacement in the circumferential direction occurs between the outer layer 11 and the inner layer 12. On the other hand, due to a force applied in an axial direction by screwing of the screw thread 13b of the neck portion 13 and the inner screw thread 33, the longitudinal rib 16 of the inner layer 12 is guided in an extending direction of the recessed portion 17, and the inner layer 12 (or the neck portion 13) is displaced so as to be lifted up to one side.

Specifically, as a first configuration example, a lower end of the cap portion 32 of the lid body 30 and an end portion of the outer layer may be brought into contact with each other, and the inner layer 12 (or the neck portion 13) may be displaced so as to be lifted up with respect to the outer layer 11 (specifically, an end portion (protruding portion 14b) of the outer layer 11) from the contact portion as a starting point. As a result, the inner layer 12 is displaced in the axial direction with respect to the outer layer 11, the outer layer 11 and the inner layer 12 open at an upper end of the container (that is, an upper surface of the protruding portion 14 of the outer layer 11 and a lower surface of the step portion 13c of the inner layer 12 (or the neck portion 13) are separated from each other), and a vent through which air passes between the outer layer 11 and the inner layer 12 is formed. Air passes between the outer layer 11 and the inner layer 12 through the vent, whereby the outer layer 11 and the inner layer 12 of the delamination container 20 can be delaminated from each other.

Note that at an upper end portion of the outer layer 11, even when the inner layer 12 is peeled from the outer layer 11, the inner layer 12 is positioned by engagement between the recessed portion 17 and the longitudinal rib 16, and therefore rattling of the neck portion 13 is suppressed. In addition, when the neck portion 13 is displaced so as to be lifted by the lid body 30, the diameter may be slightly reduced while a portion of the inner layer 12 where the longitudinal rib 16 is formed is extended. As a result, the outer layer 11 and the inner layer 12 may be peeled from each other at a lower portion of the neck portion 13 to form a gap between an outer peripheral surface of the step portion 13c and an inner peripheral surface of the protruding portion 14b while engagement between the longitudinal rib 16 and the recessed portion 17 is maintained, thereby forming a vent through which air passes.

In addition, in an example of the present embodiment, a gap as an example of a flow path is formed between the cap portion 32 of the lid body 30 and an upper end of the outer layer 11 when the lid body 30 is closed. As a result, air from the outside can directly flow into the vent between the inner layer 12 and the outer layer 11. Note that, as described above, the delamination container 20 may be configured such that the cap portion 32 of the lid body 30 and an upper end of the outer layer 11 are in contact with each other when the lid body 30 is closed.

In addition, as a second configuration example, a vent may be formed between the outer layer 11 and the inner layer 12 of the neck portion 13 by contact between the longitudinal rib 16 and the recessed portion 17 in a rotation direction when the lid body 30 is closed. In the second configuration example, contact between a lower end of the cap portion 32 of the lid body 30 and an end portion (protruding portion 14b) of the outer layer 11 is unnecessary.

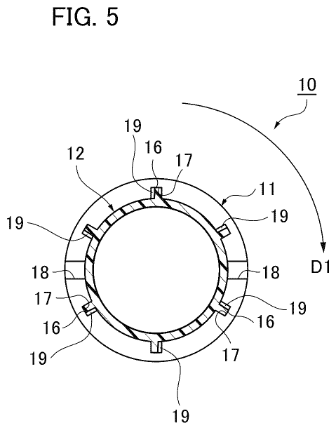

The inner layer 12 (for example, LDPE, L-LDPE, or PP) is made of a material that is softer than the outer layer 11 (for example, PET) and easily returns to an original shape after being bent (easily elastically deformed). In addition, the lid body 30 is turned in a first direction D1 (see FIG. 5) along the screw thread 13b of the neck portion 13 (inner layer 12) to be engaged with the neck portion 13. When the lid body 30 is closed, an upper end of the neck portion 13 is brought into contact with an inner surface of the lid body 30 in an airtight manner, and the screw thread 13b and an inner screw thread of the lid body are engaged with each other, whereby the lid body 30 does not rotate in the first direction D1 with respect to the neck portion 13.

After the lid body 30 is closed, when a torque is further slightly applied to the lid body 30 in the first direction D1, the neck portion 13 is slightly elastically deformed with respect to the outer layer 11. Then, initial peeling in which the inner and outer layers are separated from each other occurs at a portion on a reverse rotation side (side opposite to the first direction D1) between the longitudinal rib 16 and the recessed portion 17 functioning as a rotation prevention (initial peeling step). When the torque in the first direction D1 is released, the neck portion 13 returns to the original position, but as illustrated in FIG. 5, the gap 19 between the inner and outer layers formed at a portion of the longitudinal rib 16 and the recessed portion 17 on the reverse rotation side is maintained. As a result, a vent (gap 19) can be formed between the outer layer 11 and the inner layer 12 on the neck portion 13 side.

In addition, when the torque is applied in the first direction D1, a lower surface of the step portion 13c of the neck portion 13 which is a part of the inner layer 11 is separated from the protruding portion (first opening portion) 14b which is a part of the outer layer 12, and initial peeling occurs (initial peeling step). When the torque in the first direction D1 is released, the neck portion 13 returns to the original position, but a gap between the inner layer and outer layer formed between a lower surface of the step portion 13c and an upper surface of the protruding portion (first opening portion) 14b is maintained. As a result, on the neck portion 13 side, a gap is formed between the lower surface of the step portion 13c and the upper surface of the protruding portion (first opening portion) 14b. The gap between the step portion 13c and the protruding portion 14b communicates with the gap 19 between the longitudinal rib 16 and the recessed portion 17.

Note that, in the delamination container 20, the groove 18 is formed in a part of an upper end of the outer layer 11 in the circumferential direction. Even if the cap portion 32 and the outer layer 11 are in contact with each other, the inside and the outside of the cap portion 32 communicate with each other through a space of the groove 18, and air can be guided to an upper end side of the delamination container 20. When a gap is ensured between the cap portion 32 of the lid body 30 and the upper end of the outer layer 11, formation of the groove 18 at the upper end of the outer layer 11 may be omitted. Note that the mouth portion 13a is sealed by contact between the upper end of the neck portion 13 and the cap portion 32, and therefore contents filled in the inner layer 12 are not exposed to air.

In the delamination container 20, when the lid body 30 is opened and contents are discharged from the inner layer 12, air introduced into the cap portion 32 through the groove 18 flows into a space between the outer layer 11 and the inner layer 12 from a container upper end side, and peeling between the outer layer 11 and the inner layer 12 gradually progresses. As a result, a volume occupied by contents of the inner layer 12 in the container can be replaced with air without bringing the contents into contact with air, and the contents filled in the inner layer 12 can be discharged to the outside of the container.

In addition, when the used delamination container 20 is discarded, since the outer layer 11 and the inner layer 12 are made of different materials, the inner layer 12 needs to be removed from the outer layer 11, and sorting needs to be performed. As illustrated in FIG. 4A, in a state where the delamination container 20 is used, contents of the inner layer 12 are discharged, and the inner layer 12 is peeled from the outer layer 11 and contracted. On the other hand, the cap portion 32 of the lid body 30 is fixed to the neck portion 13 formed in the inner layer 12 by screwing.

When the lid body 30 is pulled to one side in the state of FIG. 4A, as illustrated in FIG. 4B, the contracted inner layer 12 can be pulled out from the outer layer 11, and the inner layer 12 can be removed from the outer layer 11. When the inner layer 12 is pulled out, a force for pulling out the lid body 30 to one side and a reaction force on the other side from the inner layer 12 act. When a pulling force to one side is applied to the neck portion 13 and the lid body 30, the screw thread 13b of the neck portion 13 and the inner screw thread 33 of the cap portion 32 that mesh spirally come into contact with each other in an axial direction, and a high resistance is generated against shearing in the axial direction. That is, the neck portion 13 and the lid body 30 are less likely to be separated from each other with respect to the pulling force to one side, and the pulling force to one side is transmitted to the inner layer 12 without separating the neck portion 13 and the lid body 30 from each other. As a result, the inner layer 12 can be pulled out from the outer layer 11 together with the lid body 30.

### Description of Apparatus for Manufacturing Delamination Container

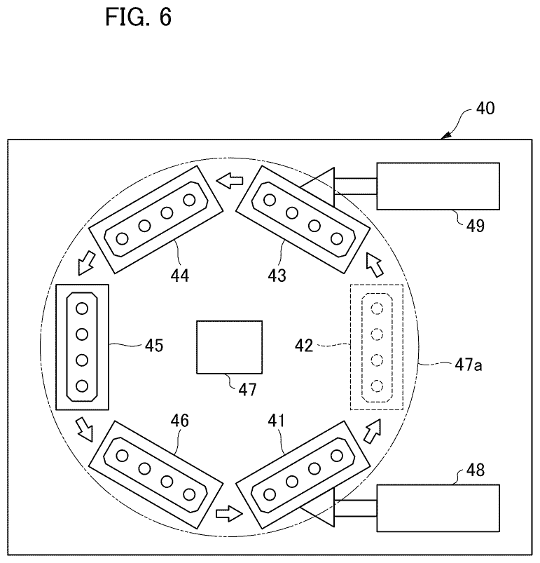

FIG. 6 is a diagram schematically illustrating a configuration of a blow molding apparatus 40 of the present embodiment. The blow molding apparatus 40 of the present embodiment is an example of an apparatus for manufacturing the delamination container 20, and adopts a hot parison type (also referred to as one stage type) that blow-molds the delamination container 20 by utilizing residual heat (internal heat quantity) from injection molding without cooling the preform 10 to room temperature.

The blow molding apparatus 40 includes a first injection molding unit 41, a first temperature adjusting unit 42, a second injection molding unit 43, a second temperature adjusting unit 44, a blow molding unit 45, a taking-out unit 46, and a conveyance mechanism 47. The first injection molding unit 41, the first temperature adjusting unit 42, the second injection molding unit 43, the second temperature adjusting unit 44, the blow molding unit 45, and the taking-out unit 46 are disposed at positions in which one position is obtained by rotation of an adjacent position by the same predetermined angle (for example, 60 degrees) around the conveyance mechanism 47. Note that the blow molding apparatus 40 may omit the first temperature adjusting unit 42. In this case, the molding stations are disposed in which one position is obtained by rotation of an adjacent position by 72 degrees around the conveyance mechanism 47.

In each of the first injection molding unit 41 and the second injection molding unit 43, a core mold lifting and lowering mechanism (not illustrated) is disposed above the conveyance mechanism 47.

### Conveyance Mechanism 47

The conveyance mechanism 47 includes a transfer plate 47a that rotates around an axis in a direction perpendicular to a paper surface of FIG. 6. On the transfer plate 47a, one or more neck molds 47b (not illustrated in FIG. 6) that hold the neck portion 13 of the preform 10 (or the delamination container 20) are disposed at each predetermined angle.

The neck mold 47b defines the shape of an upper end of the outer layer 11 including the groove 18 in the first injection molding unit 41. The neck mold 47b defines the outer peripheral shape of the neck portion 13 of the inner layer 12 in the second injection molding unit 43.

The conveyance mechanism 47 conveys the preform 10 (or the delamination container 20) held by the neck mold 47b in order of the first injection molding unit 41, the first temperature adjusting unit 42, the second injection molding unit 43, the second temperature adjusting unit 44, the blow molding unit 45, and the taking-out unit 46 by moving the position of the transfer plate 47a in a rotation direction. Note that the conveyance mechanism 47 can also move up and down the transfer plate 47a, and also performs operations related to mold closing and mold opening (mold releasing) in the first injection molding unit 41 and the second injection molding unit 43.

### First Injection Molding Unit 41

The first injection molding unit 41 includes a cavity mold 50 and a core mold 51, and manufactures the outer layer 11 of the preform 10 in cooperation with the neck mold 47b conveyed during molding. The first injection molding unit 41 is connected to a first injection device 48 that supplies a first resin material via a hot runner mold (not illustrated). The cavity mold 50 is fixed to a machine base of the blow molding apparatus 40, and the core mold 51 is fixed to the core mold lifting and lowering mechanism.

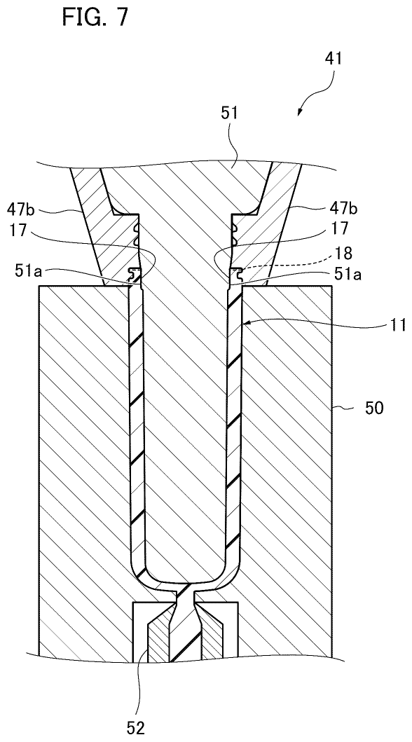

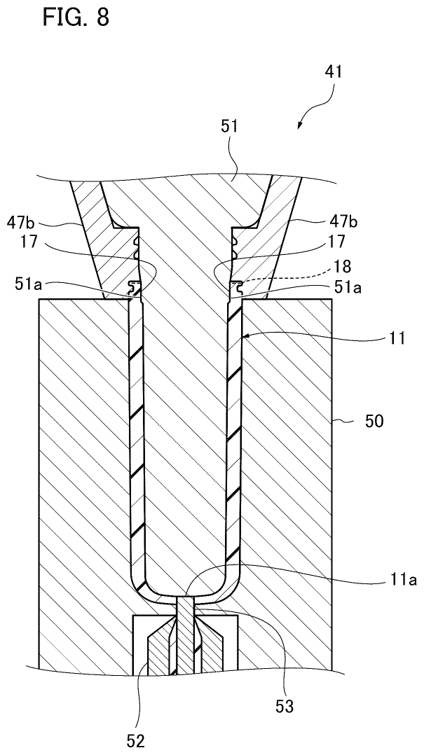

FIGS. 7 and 8 are views illustrating the first injection molding unit 41 that molds the outer layer 11 of the preform 10.

The cavity mold 50 is a mold that defines the outer peripheral shape of the outer layer 11. A resin supply unit 52 that injects the first resin material plasticized (melted) by the first injection device 48 into the cavity mold 50 is connected to a bottom portion of the cavity mold 50.

The core mold 51 is a mold that defines the shape of an inner peripheral side of the outer layer 11, and is inserted into an inner periphery of the cavity mold 50 from an upper side. In a region corresponding to an upper end of the outer layer 11 in the core mold 51, a protruding portion 51a corresponding to the recessed portion 17 of the outer layer 11 is formed in an axial direction.

The resin supply unit 52 includes a valve pin 53 that is movable in the axial direction to a position close to the core mold 51. The valve pin 53 is a rod-like member that opens and closes the resin supply unit 52, and is accommodated inside so as not to protrude from the resin supply unit 52 until the first resin material is filled into a mold space. After the first resin material is filled into the mold space, the valve pin 53 protrudes to a position close to the core mold 51 as illustrated in FIG. 8. By such movement of the valve pin 53 during injection molding, a thin film portion 11a in which the thickness of the resin material is thinner than that of a peripheral portion can be formed at a center of a bottom portion of the outer layer 11.

As illustrated in FIGS. 7 and 8, in the first injection molding unit 41, the cavity mold 50, the core mold 51, and the neck mold 47b of the conveyance mechanism 47 described above are closed to form a mold space of the outer layer 11. Then, by injecting the first resin material from a bottom portion of the above mold space via the resin supply unit 52, the outer layer 11 of the preform 10 is manufactured in the first injection molding unit 41.

Even when the molds of the first injection molding unit 41 are opened, the neck mold 47b of the conveyance mechanism 47 is not released, and the neck mold 47b is conveyed while holding the outer layer 11 of the preform 10 as it is. The number of the preforms 10 simultaneously molded by the first injection molding unit 41 (that is, the number of the delamination containers 20 that can be simultaneously molded by the blow molding apparatus 40) can be appropriately set.

### First Temperature Adjusting Unit 42

The first temperature adjusting unit 42 includes a temperature adjusting mold (not illustrated) (a heating pot or a temperature adjusting pot that externally adjusts the temperature of the outer layer 11, and a heating rod or a temperature adjusting rod (or an air introduction rod) that internally adjusts the temperature of the outer layer 11). The first temperature adjusting unit 42 cools (or heats) the outer layer 11 in a high temperature state after injection molding by accommodating the outer layer 11 in a temperature adjusting mold maintained at a predetermined temperature. The first temperature adjusting unit 42 also has a function of adjusting a temperature distribution of the outer layer 11 to a predetermined state before the outer layer 11 is conveyed to the second injection molding unit 43.

### Second Injection Molding Unit 43

The second injection molding unit 43 includes a cavity mold 60 and a core mold 61, and injection-molds the inner layer 12 on an inner peripheral side of the outer layer 11 in cooperation with the neck mold 47b conveyed during molding. The second injection molding unit 43 is connected to a second injection device 49 that supplies a second resin material via a hot runner mold (not illustrated). The cavity mold 60 is fixed to a machine base of the blow molding apparatus 40, and the core mold 61 is fixed to the core mold lifting and lowering mechanism.

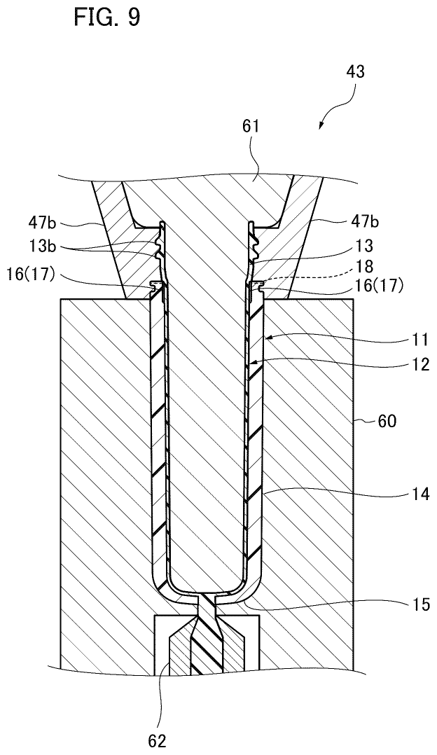

FIG. 9 is a view illustrating the second injection molding unit 43 that molds the inner layer 12 of the preform 10.

The cavity mold 60 is a mold that accommodates the outer layer 11. A resin supply unit 62 that injects the second resin material plasticized (melted) by the second injection device 49 into the cavity mold 60 is connected to a bottom portion of the cavity mold 60. The core mold 61 is a mold that defines the inner peripheral shape of the inner layer 12, and is inserted into an inner periphery of the cavity mold 60 from an upper side.

As illustrated in FIG. 9, the second injection molding unit 43 accommodates the outer layer 11 of the preform 10 injection-molded by the first injection molding unit 41. In a state where the molds of the second injection molding unit 43 are closed, a mold space is formed between an inner periphery of the outer layer 11 and surfaces of the neck mold 47b and the core mold 61. Then, by injecting the second resin material from a bottom portion of the above mold space via the resin supply unit 62, the inner layer 12 is laminated on an inner peripheral side of the outer layer 11 in the second injection molding unit 43 to manufacture the preform 10 illustrated in FIGS. 1A and 1B.

### Second Temperature Adjusting Unit 44

The second temperature adjusting unit 44 includes a temperature adjusting mold (not illustrated) (a heating pot or a temperature adjusting pot that externally adjusts the temperature of the preform 10, and a heating rod or a temperature adjusting rod (or an air introduction rod) that internally adjusts the temperature of the preform 10). By accommodating the preform 10 conveyed from the second injection molding unit 43 in a mold unit maintained at a predetermined temperature, the second temperature adjusting unit 44 performs temperature equalization and removal of uneven temperature, and adjusts the temperature of the preform 10 to a temperature suitable for final blowing (for example, about 90 °C to 105 °C). The second temperature adjusting unit 44 also has a function of cooling the preform 10 in a high temperature state after injection molding.

### Blow Molding Unit 45

The blow molding unit 45 blow-molds the preform 10 whose temperature has been adjusted by the second temperature adjusting unit 44 to manufacture the delamination container 20.

The blow molding unit 45 includes a blow cavity mold which is a pair of split molds corresponding to the shape of the delamination container 20, a bottom mold, a stretching rod, and an air introduction member (none of which is illustrated). The blow molding unit 45 blow-molds the preform 10 while stretching the preform 10. As a result, the preform 10 is shaped into the shape of a blow cavity mold, whereby the delamination container 20 can be manufactured.

### Taking-Out Unit 46

The taking-out unit 46 is configured to release the delamination container 20 manufactured by the blow molding unit 45 from the neck mold 47b and to take out the delamination container 20 to the outside of the blow molding apparatus 40.

### Description of Method for Manufacturing Container

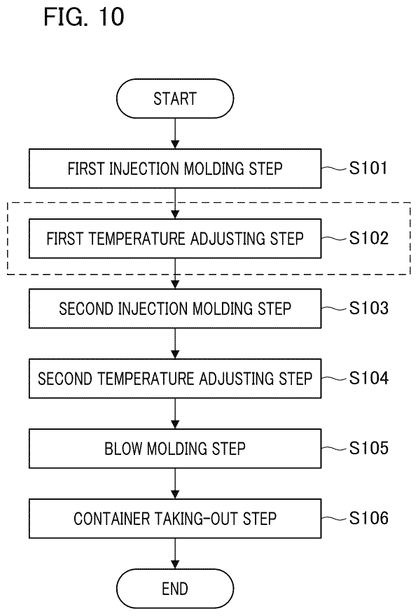

Next, a method for manufacturing the delamination container 20 with the blow molding apparatus 40 of the present embodiment will be described. FIG. 10 is a flowchart indicating steps of the method for manufacturing the delamination container 20.

### Step S101: First Injection Molding Step

First, as illustrated in FIG. 8, in the first injection molding unit 41, the first resin material is injected from the first injection device 48 into a mold space formed by the cavity mold 50, the core mold 51, and the neck mold 47b to manufacture the outer layer 11 of the preform 10. At this time, the groove 18 is formed at an upper end of the outer layer 11 by the neck mold 47b. In addition, the recessed portion 17 is formed on an inner peripheral surface in the vicinity of the upper end of the outer layer 11 by the protruding portion 51a formed in the core mold 51.

In addition, in the first injection molding unit 41, as illustrated in FIG. 8, after the outer layer 11 of the preform 10 is molded, a step of protruding the valve pin 53 to a position close to the core mold 51 is performed. As a result, the thin film portion 11a having a thinner thickness than a peripheral portion is formed at a center of a bottom portion of the outer layer 11.

Thereafter, the molds of the first injection molding unit 41 are opened, and the outer layer 11 is released from the molds. When the molds of the first injection molding unit 41 are opened, the transfer plate 47a of the conveyance mechanism 47 moves by a predetermined angle in a rotation direction. As a result, the outer layer 11 of the preform 10 held by the neck mold 47b is conveyed to the first temperature adjusting unit 42 in a state of containing residual heat from injection molding.

### Step S102: First Temperature Adjusting Step

Next, in the first temperature adjusting unit 42, the outer layer 11 of the preform 10 is accommodated in the temperature adjusting mold, and cooling of the outer layer 11 and adjustment of a temperature distribution (temperature equalization and removal of uneven temperature) of the outer layer 11 are performed. Note that the first temperature adjusting step may be omitted.

After the first temperature adjusting step (or the first injection molding step), the transfer plate 47a of the conveyance mechanism 47 moves by a predetermined angle in a rotation direction. As a result, the temperature-adjusted outer layer 11 held by the neck mold 47b is conveyed to the second injection molding unit 43.

### Step S103: Second Injection Molding Step

Subsequently, the outer layer 11 of the preform 10 is accommodated in the second injection molding unit 43, and the inner layer 12 is injection-molded.

In the second injection molding unit 43, as illustrated in FIG. 9, a mold space is formed between an inner periphery of the outer layer 11 and surfaces of the neck mold 47b and the core mold 61 facing the inner periphery and the neck mold 47b, and the second resin material is injected from the second injection device 49 into the above mold space. Note that the thin film portion 11a is formed at a bottom portion of the outer layer 11, the thin film portion 11a is ruptured by injection pressure of the second resin material to form the opening portion 15a at the bottom portion, and the second resin material is guided from the above opening portion 15a to an inner peripheral side of the outer layer 11.

In the second injection molding unit 43, the neck portion 13 of the inner layer 12 is formed by the neck mold 47b and the core mold 61, and the body portion 14 and the bottom portion 15 of the inner layer 12 are formed by an inner periphery of the outer layer 11 and the core mold 61. In addition, the second resin material is filled into the recessed portion 17 formed on the inner periphery of the outer layer 11, whereby the longitudinal rib 16 is formed on an outer periphery of the inner layer 12.

Here, the temperature of the second resin material to be filled in the second injection molding unit 43 is set to a temperature lower than a melting point of the first resin material. The surface temperature of the outer layer 11 when the second resin material is filled in the second injection molding unit 43 is cooled to a temperature equal to or lower than a melting point of the second resin material.

In the second injection molding unit 43, the cavity mold 60 faces an outer peripheral side of the outer layer 11, and the shape of the outer layer 11 is held by the cavity mold 60 from the outer peripheral side. Therefore, in the second injection molding unit 43, thermal deformation of the outer layer 11 can be suppressed even if the second resin material comes into contact with the outer layer 11.

As described above, by the first injection molding step and the second injection molding step, the inner layer 12 is laminated on the inner peripheral side of the outer layer 11 to manufacture the preform 10 illustrated in FIGS. 1A and 1B.

Thereafter, the molds of the second injection molding unit 43 are opened, and the preform 10 is released from the molds. When the molds of the second injection molding unit 43 are opened, the transfer plate 47a of the conveyance mechanism 47 moves by a predetermined angle in a rotation direction. As a result, the preform 10 held by the neck mold 47b is conveyed to the second temperature adjusting unit 44 in a state of containing residual heat from injection molding.

### Step S104: Second Temperature Adjusting Step

Subsequently, in the second temperature adjusting unit 44, the preform 10 is accommodated in a temperature adjusting mold unit, and temperature adjustment for bringing the temperature of the preform 10 close to a temperature suitable for final blow is performed. Thereafter, the transfer plate 47a of the conveyance mechanism 47 moves by a predetermined angle in a rotation direction. As a result, the temperature-adjusted preform 10 held by the neck mold 47b is conveyed to the blow molding unit 45.

### Step S105: Blow Molding Step

Subsequently, the delamination container 20 is blow-molded in the blow molding unit 45.

First, the blow cavity mold is closed, the preform 10 is accommodated in a mold space, and the air introduction member (blow core) is caused to descend, whereby the air introduction member comes into contact with the neck portion 13 of the preform 10. Then, the preform 10 is stretched in a lateral axis direction by lowering the stretching rod, holding the bottom portion 15 of the preform 10 from an inner surface, and supplying blow air from the air introduction member while performing longitudinal axis stretching as necessary. As a result, the preform 10 is bulged and shaped so as to be in close contact with the mold space of the blow cavity mold, and is blow-molded into the delamination container 20.

### Step S106: Container Taking-Out Step

When blow molding is finished, the blow cavity mold is opened. As a result, the delamination container 20 is movable from the blow molding unit 45.

Subsequently, the transfer plate 47a of the conveyance mechanism 47 moves by a predetermined angle in a rotation direction, and the delamination container 20 is conveyed to the taking-out unit 46. In the taking-out unit 46, the delamination container 20 is released from the neck mold 47b, and the delamination container 20 is taken out to the outside of the blow molding apparatus 40. Contents are filled into the manufactured delamination container 20, and the lid body 30 is attached to the delamination container 20 in a post-processing step (not illustrated).

Thus, one cycle in the method for manufacturing the delamination container ends. Thereafter, the transfer plate 47a of the conveyance mechanism 47 moves by a predetermined angle in a rotation direction, and the steps of S101 to S106 described above are repeated. Note that during operation of the blow molding apparatus 40, six sets of the delamination containers 20 having a time difference of one step are manufactured in parallel.

In addition, due to the structure of the blow molding apparatus 40, waiting times of the first injection molding step, the first temperature adjusting step, the second injection molding step, the second temperature adjusting step, the blow molding step, and the container taking-out step are the same. Similarly, a conveyance time between the steps is the same.

Hereinafter, effects of the present embodiment will be described.

The delamination container 20 of the present embodiment includes the neck portion 13, the container main body portion (body portion 14 and bottom portion 15), and the lid body 30. The neck portion 13 is formed of the inner layer 12, has the mouth portion 13a on one side, and has the screw thread 13b on an outer periphery. The container main body portion is connected to the other side of the neck portion 13, and has the outer layer 11 made of a material different from a material of the inner layer 12 laminated on an outer side of the inner layer 12. The lid body 30 is attached to the neck portion 13, and seals the mouth portion 13a with respect to air when the lid body 30 is closed.

The lid body 30 is screwed with the neck portion 13 of the inner layer 12, and the lid body 30 and the neck portion 13 generate high resistance against shearing in the axial direction. Therefore, when the inner layer 12 and the outer layer 11 of the used delamination container 20 are sorted, the neck portion 13 and the lid body 30 are hardly separated by a pulling force, and therefore it is easy to remove the inner layer 12 from the outer layer 11 together with the lid body 30.

In addition, in the present embodiment, by displacing the inner layer 12 on one side with respect to the outer layer 11 by rotation of the lid body 30 in a closing direction, a vent for guiding air between the inner layer 12 and the outer layer 11 is formed on one side of the container main body portion. Therefore, a vent for guiding air can be easily formed between the outer layer 11 and the inner layer 12. Note that, in the configuration of the present embodiment, since a vent can be easily formed when the lid body 30 is attached, it is not necessary to form a vent in the preform 10 during injection molding. Therefore, it is not necessary to add a movable mold for forming a vent to the injection molding mold, and therefore cost for manufacturing the delamination container 20 can be suppressed.

Furthermore, in the present embodiment, the outer layer 11 of the preform 10 is molded in the first injection molding step, and the inner layer 12 is injection-molded from the opening portion 15a of the outer layer 11 on an inner side of the outer layer 11 in the second injection molding step to manufacture the preform 10 having a two-layer structure. Then, the above preform 10 having a two-layer structure is subjected to stretch blow molding in a state of having residual heat from injection molding to manufacture the delamination container 20. Therefore, in the present embodiment, the delamination container 20 having excellent aesthetic appearance, physical property strength, and the like can be manufactured by a hot parison type blow molding method. As compared with cold parison type blow molding, in the present embodiment, it is not necessary to cool the manufactured preform 10 to near room temperature, and a step of reheating the preform 10 is also unnecessary. Therefore, according to the present embodiment, a series of steps from injection molding of the preform 10 to blow molding of the delamination container 20 can be completed in a relatively short time, and the delamination container 20 can be mass-produced in a shorter manufacturing cycle.

### First Modification

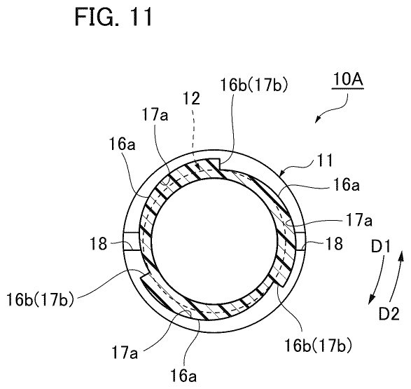

FIG. 11 illustrates another configuration example of a protrusion and a recessed portion of a preform 10A (delamination container 20) as a first modification of the above embodiment. Note that, in the following description of each modification, the same reference numerals are given to elements common to those of the above embodiment, and redundant description is appropriately omitted.

The first modification is a configuration example in which a protrusion 16a formed in the inner layer 12 of the preform 10A is formed in a ratchet tooth shape. One or more protrusions 16a are formed in a circumferential direction on an outer peripheral side of the inner layer 12, and a plurality of protrusions 16a are preferably formed at predetermined intervals (for example, equal intervals). FIG. 11 illustrates an example in which three protrusions 16a are formed in the circumferential direction of the inner layer 12, but the number of protrusions 16a is not limited to the above. Similarly to the longitudinal rib 16 in the above embodiment, each protrusion 16a extends in an axial direction from the vicinity of a boundary between the neck portion 13 and the body portion 14 toward the other side, and protrudes outward in a radial direction of the inner layer 12 on a plane orthogonal to the axial direction.

In the shape of each protrusion 16a, a protrusion amount in the radial direction increases in the first direction D1 (closing direction of the lid body 30) in which the lid body 30 is screwed with the neck portion 13, and a ratchet tooth pawl surface 16b is formed on a second direction D2 (opening direction of the lid body 30) side opposite to the first direction D1.

On the other hand, in the first modification, a plurality of recessed portions 17a corresponding to the shape of the protrusion 16a are formed at equal intervals in a circumferential direction on an inner periphery of the outer layer 11 of the preform 10A. FIG. 11 illustrates an example in which three recessed portions 17a are formed in the circumferential direction of the outer layer 11, but the number of recessed portions 17a is not limited to the above. Note that the axial length of each recessed portion 17a is an axial length corresponding to the protrusion 16a.

Each recessed portion 17a has a ratchet tooth shape matching the protrusion 16a on a plane orthogonal to the axial direction. That is, in the shape of the recessed portion 17a, the thickness of the outer layer 11 decreases in the first direction D1, and a ratchet tooth pawl surface 17b is formed on a second direction D2 side opposite to the first direction D1.

Also in the delamination container 20 in which the preform 10A of the first modification is blow-molded, the neck portion 13 of the preform 10A and an upper end portion of the outer layer 11 are held by the neck mold 47b during blow molding, and the shape of the preform 10A is maintained as it is. Therefore, the neck portion 13 of the delamination container 20 and the upper end portion of the outer layer 11 have similar configurations to that of the neck portion 13 of the preform 10A described above. That is, the recessed portion 17a having a ratchet tooth shape is formed in the outer layer 11 in the upper end portion of the outer layer 11 of the delamination container 20, and the protrusion 16a having a ratchet tooth shape is formed in the inner layer 12 at the portion.

When the lid body 30 is attached to the delamination container 20 of the first modification, the cap portion 32 of the lid body 30 is put on the neck portion 13, and the lid body 30 is rotated in the first direction D1 with respect to the neck portion 13. As a result, the screw thread 13b of the neck portion 13 and the inner screw thread 33 of the lid body 30 are screwed together, and the lid body 30 is fixed to the neck portion 13 of the delamination container 20.

Here, when the lid body 30 is screwed with the screw thread 13b of the neck portion 13, while the outer layer 11 of the delamination container 20 is held by an operator and stands still, a torque in the first direction D1 is applied to the inner layer 12 having the neck portion 13 by attachment of the lid body 30. Then, the pawl surface 16b of the protrusion 16a of the inner layer 12 directed in the first direction D1 comes into contact with the pawl surface 17b of the recessed portion 17a of the outer layer 11 that stands still, and the protrusion 16a is caught and locked in the recessed portion 17a. As a result, when the lid body 30 is screwed with the screw thread 13b of the neck portion 13, the inner layer 12 is prevented from rotating with respect to the outer layer 11, and relative rotation between the outer layer 11 and the inner layer 12 does not occur.

On the other hand, when the lid body 30 is removed from the delamination container 20 of the first modification, the lid body 30 is rotated in the second direction D2 with respect to the neck portion 13. At this time, while the outer layer 11 of the delamination container 20 is held by an operator and stands still, a torque in the second direction D2 is applied to the inner layer 12 having the neck portion 13. In this case, the protrusion 16a of the inner layer 12 can move in the second direction D2 without being blocked by the pawl surface 17b of the recessed portion 17a of the outer layer 11. The protrusion 16a that moves in the second direction D2 is guided by an inclined surface of the recessed portion 17a, and is movable over a step of the pawl surface 17b of the outer layer 11. As a result, when the lid body 30 is removed from the neck portion 13, the inner layer 12 can be easily rotated relative to the outer layer 11 in the second direction.

Note that the inner layer 12 may be supported by the outer layer 11 in the opening portion 25a of the bottom portion 25. In this case, when a torque is applied to the inner layer 12 in the second direction D2 on a neck portion 13 side, the contracted inner layer 12 is deformed so as to be twisted with a bottom portion 25 side as a fulcrum, and can be formed into a shape that is narrowed and easily pulled out. Thereafter, an operator can remove the inner layer 12 from the outer layer 11 by pulling the lid body 30 to one side and pulling out the contracted inner layer 12 from the outer layer 11.

As described above, according to the first modification, the inner layer 12 can be rotated relative to the outer layer 11 when the lid body 30 is removed from the delamination container 20 while relative rotation between the outer layer 11 and the inner layer 12 is prevented when the lid body 30 is attached to the delamination container 20. Therefore, in the first modification, workability when the inner layer 12 is removed from the outer layer 11 after use of the delamination container 20 and sorting is performed is further improved.

Note that a method and an apparatus for manufacturing the delamination container 20 to which the preform 10A of the first modification is applied are different from the case of manufacturing the delamination container 20 by applying the preform 10 only in the appearance shape of the core mold (not illustrated) of the first injection molding unit 41. In a region corresponding to an upper end of the outer layer 11 in the core mold (not illustrated), a protruding portion corresponding to the recessed portion 17a of the outer layer 11 (or corresponding to the ratchet tooth-shaped protrusion 16a of the inner layer 12) is formed in the axial direction.

### Second Modification

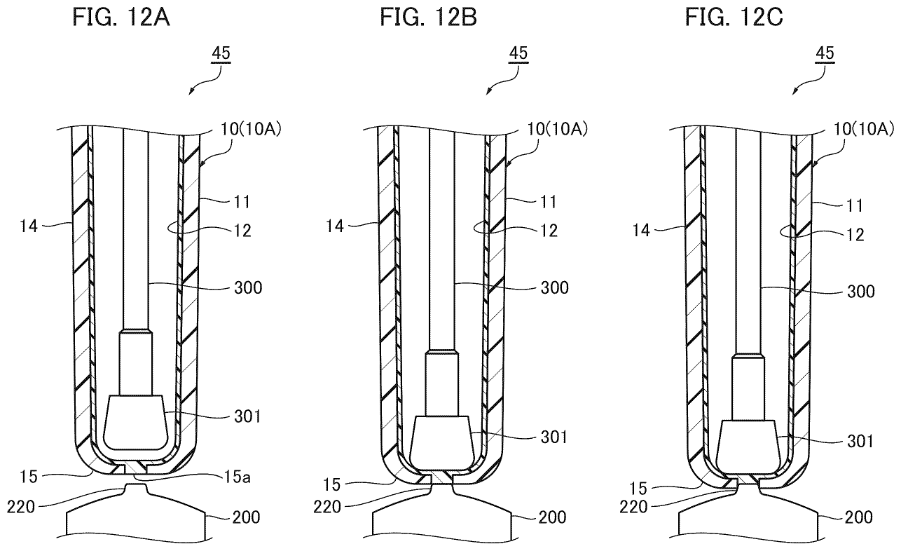

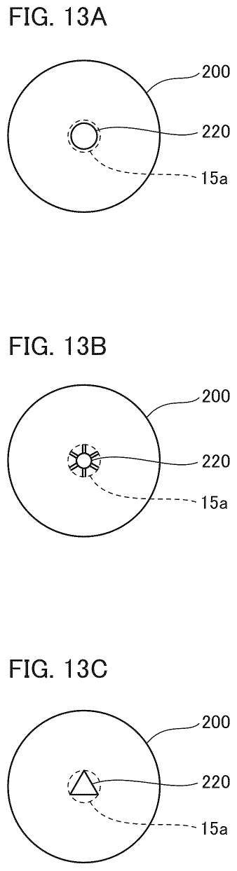

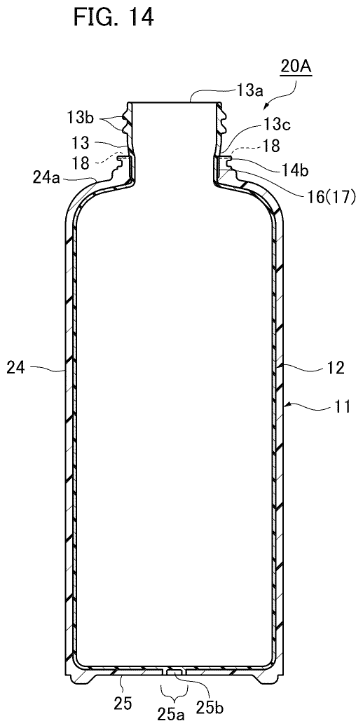

FIG. 12 A to 12C illustrate an example of a blow molding step (S105) in the blow molding unit 45 as a second modification of the above embodiment. FIGS. 13A to 13C are plan views of a bottom mold 200 illustrated in FIGS. 12A to 12C. FIG. 14 is a cross-sectional view illustrating a configuration example of a delamination container 20A manufactured in the second modification.

As illustrated in FIGS. 12A to 12C, the blow molding unit 45 according to the second modification includes a blow cavity mold which is a pair of split molds corresponding to the shape of the delamination container 20, the bottom mold 200, a stretching rod 300 extending in an vertical direction in the drawing, and an air introduction member (not illustrated, a member that is in contact with the neck portion 13 of each of the preforms 10 and 10A and supplies and exhausts air). Here, the stretching rod 300 has a lower end portion (end piece portion) 301 having a larger diameter than an intermediate portion (hollow rod portion) in order to increase a contact area with the bottom portion 15 of the preform 10 on a lower end side. Note that, in each drawing of FIGS. 12A to 12C, the blow cavity mold in the blow molding unit 45 is not illustrated.

The bottom mold 200 has a protruding portion 220 extending upward in FIGS. 12A to 12C at a position corresponding to the opening portion 15a of the outer layer 11. FIGS. 13A to 13C illustrate shape examples of the protruding portion 220 of the bottom mold 200. As illustrated in each drawing of FIGS. 13A to 13C, the width of the protruding portion 220 (dimension in a left-right direction in FIGS. 12A to 12C) is formed to be smaller than the width dimension of the opening portion 15a of the outer layer 11 (in FIGS. 13A to 13C, the opening portion 15a is indicated by a broken line). Therefore, the protruding portion 220 can be inserted into the opening portion 15a of the bottom portion 15 which penetrates the outer layer 11 and where the inner layer 12 is exposed to the outside.

In addition, the shape of the protruding portion 220 may be a circular shape having a diameter smaller than that of the opening portion 15a as illustrated in FIG. 13A, may be a non-circular shape having one or more protruding ribs protruding in a radial direction as illustrated in FIG. 13B, or may be a polygonal shape (for example, a triangular shape) having a corner portion protruding in a radial direction as illustrated in FIG. 13C. Note that the shape of the protruding portion 220 of the bottom mold 200 is not limited to the above, and for example, the number of protruding ribs may be arbitrarily changed in the protruding portion 220 of FIG. 13B, and the shape of the protruding portion 220 of FIG. 13C may be changed to a shape of another polygon such as a quadrangle or a pentagon, a star, or the like.

FIG. 12A illustrates a state after the preform 10 (or the preform 10A) is disposed in the blow molding unit 45 and before the lower end portion 301 of the stretching rod 300 comes into contact with the bottom portion 15 of the preform 10. The bottom mold 200 in FIG. 12A is raised to a molding position where the bottom mold 200 is not in contact with the bottom portion 15 of the preform 10 and stands by before the blow cavity mold is closed. At this time, the protruding portion 220 of the bottom mold 200 is located in the vicinity below the opening portion 15a of the outer layer 11 and is not inserted into the opening portion 15a of the outer layer 11. Subsequently, the blow cavity mold is closed, and the bottom mold 200 at the molding position closes a bottom portion side of the blow cavity mold.

FIG. 12B illustrates a state where the stretching rod 300 has descended from FIG. 12B. When the stretching rod 300 descends toward the bottom portion 15 of the preform 10 after the blow cavity mold is closed, the lower end portion 301 of the stretching rod 300 comes into contact with a bottom portion of the inner layer 12 as illustrated in FIG. 12B, and stretching of the preform 10 in a longitudinal axis direction starts.

On the other hand, when the preform 10 is stretched by the stretching rod 300, as illustrated in FIG. 12B, the protruding portion 220 of the bottom mold 200 is inserted into the opening portion 15a of the outer layer 11. As a result, an upper end portion of the protruding portion 220 comes into contact with the inner layer 12 filled in the opening portion 15a.

FIG. 12C illustrates a state where the stretching rod 300 has further descended from FIG. 12B. When the stretching rod 300 further descends from the state of FIG. 12B, an upward reaction force acts on the inner layer 12 in the opening portion 15a from the bottom mold 200.

When the stretching rod 300 starts to descend or is descending (for example, FIG. 12B) or when the stretching rod 300 finishes descending (for example, FIG. 12C), supply of blow air into the preform 10 via the air introduction member starts. As a result, the preform 10 is stretched in a lateral axis direction by the blow air in a mold space formed by the blow cavity mold and the bottom mold 200, and is shaped into the shape of the delamination container 20. Note that at the time of Supplying the blow air, it is preferable to maintain a state where the lower end portion 301 of the stretching rod 300 is not separated from an inner surface of a bottom portion of the inner layer 12 at least until the inner layer 12 and the protruding portion 220 come into contact with each other.

Here, in this type of delamination container, an undercut portion may be provided at the bottom portion of the inner layer 12, and the undercut portion may be inserted into the opening portion of the bottom portion of the outer layer 11 to engage the inner layer 12 with the outer layer 11. The delamination container having the above structure can relatively strongly engage the inner layer 12 with the outer layer 11, but on the other hand, a large force is required when the inner layer 12 and the outer layer 11 are separated from each other.

On the other hand, in the second modification, the inner layer 12 is pressed from below by the protruding portion 220 inserted into the opening portion 15a of the outer layer 11, and an upward force is applied from the protruding portion 220 to a lower surface of the bottom portion of the inner layer 12. In addition, the inner layer 12 is pressed from above by the lower end portion 310 of the stretching rod 300, and a downward force is applied to an upper surface of the bottom portion of the inner layer 12. That is, the bottom portion of the inner layer 12 is pressed from below and from above, and the bottom portion of the inner layer corresponding to the protruding portion 220 is thinned. As a result, in the delamination container 20A of the second modification, as illustrated in FIG. 14, the shape of the protruding portion 220 of the bottom mold 200 is transferred to the inner layer 12 located in the opening portion 25a to form a recessed portion 25b recessed toward the inside of the container on an outer surface side. By forming the recessed portion 25b in the inner layer 12 in the opening portion 25a of the bottom portion 25, the axial thickness of the inner layer 12 disposed in the opening portion 25a decreases, and the radial thickness of the inner layer 12 located in the opening portion 25a also decreases.

As a result, in the delamination container 20A of the second modification, rigidity of the inner layer 12 disposed in the opening portion 25a decreases, and when the inner layer 12 is removed from the outer layer 11 after use of the delamination container 20A, the inner layer 12 is easily removed from the outer layer 11 in the opening portion 25a. In addition, when the inner layer 12 is removed from the outer layer 11, an event in which the inner layer 12 is broken in the opening portion 25a and a thin piece of the inner layer 12 remains in the outer layer 11 hardly occurs.

As described above, in the delamination container 20A of the second modification, an operator can easily separate the inner layer 12 and the outer layer 11 from each other without strongly pulling the inner layer 12, and workability at the time of removing the inner layer 12 from the outer layer 11 after using the delamination container 20A and performing sorting is further improved.

Note that, in the second modification, as illustrated in FIGS. 13B and 13C, when the protruding portion 220 of the bottom mold 200 has a shape having a rib or a corner portion protruding in a radial direction, a portion having a thinner thickness than other portions or a portion away from the opening portion 25a of the outer layer 11 can be formed in the recessed portion 25b of the inner layer 12. These portions can function as a vent through which air is introduced between the inner layer 12 and the outer layer 11 from the bottom portion 25 side when the delamination container 20A is used.

The present invention is not limited to the above embodiment and modifications, and various improvements and design changes may be made without departing from the gist of the present invention. For example, any one of the first modification and the second modification may be combined with the configuration of the above embodiment (including at least one of the first configuration example and the second configuration example), or both the first modification and the second modification may be combined therewith.

In the above embodiment, as an example of the flow path, a radially penetrating hole may be formed in an outer periphery of the cap portion 32 such that air from the outside can flow into the vent. Also in this case, formation of the groove 18 at an upper end of the outer layer 11 can be omitted.

Note that, in the present embodiment, the configuration in which the nozzle head 31 having a pump function is provided as the lid body 30 has been exemplified, but the lid body 30 may be, for example, a cap with a check valve without a pump.

In addition, in the above embodiment, a gap may be formed between the longitudinal rib 16 of the inner layer 12 and the recessed portion 17 of the outer layer 11 due to a difference in contraction ratio between the inner layer 12 and the outer layer 11 after blow molding. Similarly, a gap may be formed between a lower surface of the step portion 13c and an upper surface of the protruding portion (first opening portion) 14b. In this case, when the lid body 30 is locked to the neck portion 13 of the inner layer 12, since the longitudinal rib 16 and the recessed portion 17, or the step portion 13c and the protruding portion 14b are separated from each other in advance, it is easier to form a vent through which air passes between the outer layer 11 and the inner layer 12 in the vicinity of the neck portion 13.

In addition, the embodiment disclosed herein is to be considered in all respects as illustrative and not restrictive. The scope of the present invention is indicated not by the above description but by the claims, and is intended to include meanings equivalent to the claims and all modifications within the scope.

1. A delamination container comprising:
a neck portion which is formed of an inner layer, has a mouth portion on one side, and has a screw thread formed on an outer periphery; and
a container main body portion which is connected to the other side of the neck portion, and has an outer layer made of a material different from a material of the inner layer laminated on an outer side of the inner layer, wherein
a protruding portion having a diameter larger than a diameter of the neck portion is formed on one side of the container main body portion adjacent to the neck portion,
a lid body is screwable with the neck portion of the inner layer, and
by displacing the inner layer on the one side or in a circumferential direction with respect to the outer layer by rotation of the lid body in a closing direction, a vent for guiding air between the inner layer and the outer layer is formed on the one side of the container main body portion.

2. The delamination container according to claim 1, wherein
the container main body portion includes a rotation preventing portion that guides the inner layer to be displaced to the one side with respect to the outer layer while resisting displacement of the inner layer in the circumferential direction with respect to the outer layer when the lid body is rotated in a closing direction.

3. The delamination container according to claim 2, wherein
the rotation preventing portion includes:
a protrusion formed on an outer periphery of the inner layer and extending in an axial direction of the container; and
a recessed portion which is formed on an inner periphery of the outer layer and receives the protrusion.

4. The delamination container according to claim 3, wherein
in the rotation preventing portion, the protrusion is locked to the recessed portion when the lid body is rotated in a closing direction, and the protrusion is movable in an opening direction with respect to the recessed portion when the lid body is rotated in the opening direction.

5. The delamination container according to claim 1, wherein
the lid body or the outer layer further includes a flow path for introducing air outside the container toward the vent.

6. The delamination container according to claim 1, wherein
the container main body portion has, at a bottom portion, an opening portion which penetrates the outer layer and where the inner layer is exposed to an outside, and
a recessed portion recessed toward an inside of the container is formed on an outer surface side in the inner layer located in the opening portion.

7. A delamination container comprising:
a neck portion which is formed of an inner layer, has a mouth portion on one side, and has a screw thread formed on an outer periphery; and
a container main body portion which is connected to the other side of the neck portion, and has an outer layer made of a material different from a material of the inner layer laminated on an outer side of the inner layer, wherein
a protruding portion having a diameter larger than a diameter of the neck portion is formed on one side of the container main body portion adjacent to the neck portion,
a lid body is screwable with the neck portion of the inner layer, and
the container main body portion includes a rotation preventing portion that resists displacement between the outer layer and the inner layer in a circumferential direction when the lid body is rotated in a closing direction.

8. The delamination container according to claim 7, wherein
the rotation preventing portion includes:
a protrusion formed on an outer periphery of the inner layer and extending in an axial direction of the container; and
a recessed portion which is formed on an inner periphery of the outer layer and receives the protrusion.

9. The delamination container according to claim 8, wherein
in the rotation preventing portion, the protrusion is locked to the recessed portion when the lid body is rotated in a closing direction, and the protrusion is movable in an opening direction with respect to the recessed portion when the lid body is rotated in the opening direction.

10. A method for manufacturing a delamination container including:
a neck portion which is formed of an inner layer, has a mouth portion on one side, and has a screw thread formed on an outer periphery; and
a container main body portion which is connected to the other side of the neck portion, and has an outer layer laminated on an outer side of the inner layer, the method comprising:
injection-molding an outer layer of a preform corresponding to the container main body portion with a first resin material, as a first injection molding;
injecting a second resin material different from the first resin material and laminating the inner layer corresponding to the neck portion and the container main body portion inside the outer layer, as a second injection molding; and
blow-molding the preform obtained in the second injection molding in a state of having residual heat from injection molding to manufacture a delamination container.

11. The method for manufacturing a delamination container according to claim 10, wherein
the container main body portion includes a rotation preventing portion that resists displacement between the outer layer and the inner layer in a circumferential direction when a lid body screwed with the neck portion is rotated in a closing direction.

12. An apparatus for manufacturing a delamination container including:
a neck portion which is formed of an inner layer, has a mouth portion on one side, and has a screw thread formed on an outer periphery; and
a container main body portion which is connected to the other side of the neck portion, and has an outer layer laminated on an outer side of the inner layer, the apparatus comprising:
a first injection molding unit configured to injection-mold an outer layer of a preform corresponding to the container main body portion with a first resin material;
a second injection molding unit configured to inject a second resin material different from the first resin material and laminate the inner layer corresponding to the neck portion and the container main body portion inside the outer layer; and
a blow molding unit configured to blow-mold the preform obtained in the second injection molding unit in a state of having residual heat from injection molding to manufacture a delamination container.

13. The apparatus for manufacturing a delamination container according to claim 12, wherein
the container main body portion includes a rotation preventing portion that resists displacement between the outer layer and the inner layer in a circumferential direction when a lid body screwed with the neck portion is rotated in a closing direction.
